(19) United States
(12) Patent Application Publication
(10) Pub. No.: US 2021/0141469 A1
(43) Pub. Date: May 13, 2021

(54) DIGITAL PEN FOR COMPUTING DEVICES

(71) Applicant: HEWLETT-PACKARD DEVELOPMENT COMPANY, L.P., Houston, TX (US)

(72) Inventors: Monji G JABORI, Houston, TX (US); Jose Ticy LO, Houston, TX (US); Aaron J SLESSINGER, Houston, TX (US)

(73) Assignee: HEWLETT-PACKARD DEVELOPMENT COMPANY, L.P., Houston, TX (US)

(21) Appl. No.: 16/074,186

(22) PCT Filed: Sep. 23, 2016
(86) PCT No.: PCT/US2016/053418

§ 371 Date: Jul. 31, 2018

(51) Int. Cl. G06F 3/0354; G06F 3/039

(52) U.S. Cl. CPC G06F 3/03545; G06F 3/0393

(57) ABSTRACT

Examples disclosed herein provide a digital pen for a computing device. As an example, the digital pen can include a barrel and a clip. As an example, the clip includes a first end that includes a male electrical connector, and a second end opposite to the first end. As an example, the clip is attachable to the barrel from either end of the clip.

### BACKGROUND

The emergence and popularity of mobile computing has made portable computing devices, due to their compact design and light weight, a staple in today's marketplace. Computing devices, such as notebook computers and tablet computers, generally include a display member that is utilized to provide a viewable display to a user. The viewable display may be a touchscreen, allowing the user to interact directly with what is displayed by touching the screen with simple or multi-touch gestures.

### BRIEF DESCRIPTION OF THE DRAWINGS

FIG. 1A illustrates a digital pen with an accessible male electrical connector that may be used for recharging batteries of the digital pen, according to an example;

FIG. 1B illustrates the digital pen in a usage/inking mode, with the clip attached to the barrel via the male electrical connector, according to an example; and

FIG. 2 illustrates the digital pen in charging mode, with the male electrical connector accessible to be connectable into a port of a computing device for charging, according to an example.

### DETAILED DESCRIPTION

As an example, an input device, such as a digital pen, may be used with a computing device, such as a tablet computer, to capture handwriting or brush strokes of a user. The tablet computer may convert handwritten analog information, provided by the digital pen, into digital data, enabling the data to be utilized in various applications on the tablet computer. As an example, the digital pen may be powered by rechargeable batteries. When the battery power of the digital pen is exhausted, a charger is then needed to charge up the rechargeable batteries.

Examples disclosed herein provide a digital pen for a computing device that has a connector incorporated within the digital pen itself, for accessing power provided via a port of the computing device to charge the rechargeable batteries. As will be further described, the connector may be incorporated in a clip that is attachable to the digital pen, which may be accessible when charging is required. However, when the digital pen no longer needs to be charged, or is in a usage/inking mode, the connector may be hidden from view, and the clip may be used for stowing away the digital pen.

With reference to the figures, FIG. 1A illustrates a digital pen 100 with an accessible male electrical connector 110 that may be used for recharging batteries of the digital pen 100, according to an example. The digital pen 100 includes a barrel 104 that houses the circuitry and rechargeable batteries for powering the digital pen 100. Further, the digital pen 100 includes a dip 102 that has varied usage, based on the operation mode that the digital pen 100 is in. For example, either a first end 108 or a second end 106 of the clip 102 may be attachable to the barrel. As illustrated, the male electrical connector 110 may be part of the clip 102 and disposed on the first end 108 of the dip 102.

As will be further described, an orientation of the dip 102 with respect to the barrel 104 (i.e., whether the first end 108 or second end 106 is attached to the barrel 104) determines the accessibility of the male electrical connector 110, which may be used for charging the digital pen 100. For example, while in charging mode, the male electrical connector 110 may be exposed for plugging into a port of the computing device, and a first set of terminals 112₁, 112₂ on a second end 106 of the clip 102 may be electrically coupled with a second set of terminals 118₁, 118₂ on the barrel 104, in order for power to be transferred from the computing device to the rechargeable batteries in the barrel 104 of the digital pen 100. As an example of terminals, pogo pins may be used for the electrical coupling. The number of terminals used may vary from what is illustrated.

As an example, in order to ensure that the clip 102 remains coupled to the barrel 104 while the digital pen 100 is in charging mode, the clip 102 may include a first magnetic member or first set of magnetic members 114₁, 114₂ on the second end 106 to magnetically couple with a second magnetic member or second set of magnetic members 120₁, 120₂ on the barrel 104. The number of magnetic members used may vary from what is illustrated. In addition, fasteners other than magnetic members may be used to ensure that the clip 102 remains coupled to the barrel 104 while the digital pen 100 is in charging mode

When the digital pen 100 is to be operated in a first operation mode (e.g., usage/inking mode), the clip 102 may be attachable to the barrel 104 from the first end 108 of the clip 102. As illustrated in FIG. 1A, a receptacle 116 of the barrel 104 may receive the male electrical connector 110, in order to stow away the connector 110 and keep it hidden from view (illustrated by the arrow).

FIG. 1B illustrates the digital pen 100 in the usage/inking mode, with the clip 102 attached to the barrel 104, via the male electrical connector 110 from the first end 108 of the clip 102 into the receptacle 106 of the barrel 104, according to an example. By keeping the male electrical connector 110 stowed away in the receptacle 116 while the digital pen 100 is in usage/inking mode, damage to the connector 110 may be avoided. As an example, the receptacle 116 may be fitted to keep the connector 110 secured to the barrel 104 until a sufficient force is applied to remove the clip 102 from the barrel 104. For example, the receptacle 116 may include spring-loaded tabs to fit into indentations on the connector 110 (not illustrated), in order to keep the connector 110 secured to the barrel 104. By ensuring that the clip 102 remains secured to the barrel 104, the clip may be used for stowing away the digital pen, for example, in a shirt pocket or loop on a case of the computing device. As an example, magnetic members may be used to secure the male electrical connector 110 within the receptacle 116, until a sufficient force is applied to overcome the magnetic coupling provided by the magnetic members.

When the digital pen 100 is to be charged, the digital pen 100 may be switched to a second operation mode, or charging mode, where the male electrical connector 110 may be exposed (e.g., see FIG. 2), so that the male electrical connector 110 can be connected to a port of the computing device, for accessing power from the computing device to charge the rechargeable batteries of the digital pen (e.g., rechargeable batteries disposed in the barrel 104 of the digital pen 100). As will be further described, the clip 102 may be switched from its orientation when the digital pen 100 is in usage/inking mode (e.g., see FIG. 1), and the second end 106 of the clip 102 may be attachable to the barrel 104, in order to make the male electrical connector 110 accessible for charging the digital pen 100.

FIG. 2 illustrates the digital pen 100 in charging mode, with the male electrical connector 110 accessible to be connectable into a port of the computing device for charging, according to an example. As illustrated, the second end 106 of the clip 102, opposite the first end 108, includes the first set of terminals 112₁, 112₂ for electrically coupling with the second set of terminals 118₁, 118₂ on the barrel 104. As an example, the first set of terminals 112₁, 112₂ may be wired to the male electrical connector 110 and the second set of terminals 118₁, 118₂ may be wired to the rechargeable batteries in the barrel 104. As a result, once the male electrical connector 110 is connected into the port of the computing device for charging, power may be transferred from the port of the computing device for charging the rechargeable batteries in the digital pen (i.e., via the first and second set of terminals electrically coupled to each other).

In order to ensure that the first set of terminals 112₁, 112₂ remains electrically coupled with the second set of terminals 118₁, 118₂, various types of fasteners may be used. For example, the clip 102 and the barrel 104 may include a combination of magnetic members, for the clip 102 to remain magnetically coupled with the barrel 104 and in a particular orientation, so that the first set of terminals 112₁, 112₂ remains electrically coupled with the second set of terminals 118₁, 118₂. Referring to FIG. 2 as an example, magnetic member 114₁ of the clip 102 may magnetically couple with magnetic member 120₁ of the barrel 104. Similarly, magnetic member 114₂ of the clip 102 may magnetically couple with magnetic member 120₂ of the barrel 104.

Properties of the magnetic members that may be controlled include, but are not limited to, field strength and magnetic polarity. With regards to field strength, when detaching the clip 102 from the barrel 104, for example, when switching from the charging mode back to the usage/inking mode, the releasing force required to overcome the magnetic coupling between the magnetic members may be determined by controlling the field strength of the magnetic members. This releasing force may also be used to break the magnetic coupling between the clip 102 and the barrel 104 in order to avoid any damage to the male electrical connector 110 or any other component of the digital pen 100 or computing device. For example, if the digital pen 100 is inadvertently struck while male electrical connector 110 is plugged into the port of the computing device for charging, if the force is sufficient to break the magnetic coupling between the magnetic members of the clip 102 and the barrel 104, the clip 102 may remain connected to the port of the computing device and no longer attached to the barrel 104 of the digital pen 100. The barrel 104 may be simply magnetically recoupled to the clip 102 in order to resume charging.

With regards to magnetic polarity, magnetic elements having the same polarity (e.g., N-N or S-S) may generate a negative or repulsive magnetic force, whereas those corresponding magnetic elements having opposite polarities (e.g., N-S) will generate a positive or attractive magnetic force. Referring to FIG. 2, a north pole of the magnetic member 114₁ of the clip 102 may generate a positive or attractive magnetic force with a south pole of the magnetic member 120₁ of the barrel 104. Similarly, a south pole of the magnetic member 114₂ of the clip 102 may generate a positive or attractive magnetic force with a north pole of the magnetic member 120₂ of the barrel 104. This positive or attractive magnetic force may be generated when the clip 102 is placed within proximity of the barrel 104. When detaching the clip 102 from the barrel 104, for example, when switching back to usage/inking mode, the releasing force described above may be required.

As an example, the magnetic member used to attach the clip 102 to the barrel 104 for charging mode can assure the clip 102 may only attach to the barrel 104 in a specific orientation. For example, it may not be desirable to attach the clip 102 to the barrel 104 in an orientation that is reversed from what is illustrated in FIG. 2 (e.g., 114₁ to 120₂ and 114₂ to 120₁). This also reverses the orientation of the electrical coupling between the first set of terminals 112₁, 112₂ and the second set of terminals 118₁, 118₂, which may be undesirable. As an example, this reverse orientation may be avoided by controlling properties of one or more of the magnetic members of the clip 102 and barrel 104, such as the magnetic polarity, as described above. Therefore, any attempt made to attach the clip 102 and the barrel 104 in a reverse orientation may generate a repulsive magnetic force rather than an attractive magnetic force.

In addition to ensuring that the clip 102 and barrel 104 may attach in a specific orientation, the magnetic members of the clip 102 and barrel 104 may also assure proper alignment and positioning of the clip 102 with respect to the barrel 104. As a result, when transitioning to charging mode, a user may attach the clip 102 to the barrel 104 in a desired and repeatable manner, such that they are consistently in a pre-determined position relative to one another. As a result, the first set of terminals 112₁, 112₂ may electrically couple with the second set of terminals 118₁, 118₂ each time the second end 106 of the clip 102 is brought within proximity of the barrel 104, as illustrated in FIG. 2.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A digital pen for a computing device, the digital pen comprising:
a barrel; and
a clip comprising:
a first end comprising a male electrical connector, and
a second end opposite to the first end, wherein the second end comprises a first set of terminals, wherein the dip is attachable to the barrel from either end of the clip.

2. The digital pen of claim 1, wherein the barrel comprises a receptacle to receive the male electrical connector of the clip when the digital pen is to be operated in a first operation mode and the dip is attachable to the barrel from the first end of the clip.

3. The digital pen of claim 1, wherein the barrel comprises a second set of terminals to electrically couple with the first set of terminals when the digital pen is to be operated in a second operation mode and the dip is attachable to the barrel from the second end of the clip.

4. The digital pen of claim 3, wherein the second end of the clip comprises a first magnetic member to magnetically couple the clip with a second magnetic member of the barrel when the clip is attachable to the barrel from the second end of the clip.

5. The digital pen of claim 4, wherein when the digital pen is to be operated in the second operation mode, the male electrical connector is connectable to a port of the computing device for charging the digital pen, wherein power is to be transferred from the port of the computing device to the digital pen via the first and second set of terminals.

6. The digital pen of claim 5, wherein the power is to be transferred from the computing device to the digital pen until a sufficient force is to be applied to break the magnetic coupling between the first and second magnetic members, wherein the clip is then to remain connected to the port of the computing device and no longer attached to the barrel of the digital pen.

7. The digital pen of claim 3, wherein the first and second set of terminals comprise pogo pins.

8. A digital pen for a computing device, the digital pen comprising:
a clip comprising:
a first end comprising a male electrical connector; and
a second end opposite to the first end, wherein the second end comprises a first set of magnetic members; and
a barrel comprising:
a second set of magnetic members to magnetically couple the barrel with the first set of magnetic members when the clip is attachable to the barrel from the second end of the dip.

9. The digital pen of claim 8, wherein the barrel comprises a receptacle to receive the male electrical connector of the clip when the digital pen is to be operated in a first operation mode and the dip is attachable to the barrel from the first end of the clip.

10. The digital pen of claim 8, wherein:
the dip comprises a first set of terminals, and
the barrel comprises a second set of terminals to electrically couple with the first set of terminals when the digital pen is to be operated in a second operation mode and the dip is attachable to the barrel from the second end of the clip.

11. The digital pen of claim 10, wherein the first and second sets of terminals are to remain electrically coupled to each other while the first and second sets of magnetic members are to remain magnetically coupled to each other.

12. The digital pen of claim 11, wherein the first and second sets of magnetic members are to remain magnetically coupled to each other until a force is applied to overcome the magnetic coupling.

13. The digital pen of claim 8, wherein a first magnet of the first set of magnetic members of the clip is to have a different magnetic polarity from a second magnet of the first set of magnetic members of the clip, wherein the different magnetic polarities are to ensure that the clip is to be magnetically coupled to the barrel in a particular orientation.

14. A clip for a digital pen, the clip comprising:
a first end comprising a male electrical connector; and
a second end opposite to the first end, wherein the second end comprises:
a first set of terminals, wherein the clip is attachable to a barrel of the digital pen from either end of the clip; and
a first magnetic member to magnetically couple the clip with a second magnetic member of the barrel when the clip is attachable to the barrel from the second end of the clip.

15. The clip of claim 14, wherein when the digital pen is to be operated in a charging mode, the male electrical connector is connectable to a port of a computing device for charging the digital pen, wherein power is to be transferred from the port of the computing device to the digital pen via the first set of terminals and a second set of terminals of the barrel.
